(19) United States
(12) Patent Application Publication
(10) Pub. No.: US 2024/0322854 A1
(43) Pub. Date: Sep. 26, 2024

(54) PASSIVE RADIO SIGNAL CONDITIONING

(71) Applicant: Schroff Technologies International, Inc., North Kingston, RI (US)

(72) Inventors: Sridhar Arunachalam, Hillsborough, NJ (US); Janusz Pelesz, Union, NJ (US); Darioush Charepoo, Buford, GA (US)

(21) Appl. No.: 18/615,368

(22) Filed: Mar. 25, 2024

Related U.S. Application Data
(60) Provisional application No. 63/454,378, filed on Mar. 24, 2023.

(51) Int. Cl. H04B 1/405; H04L 5/14

(52) U.S. Cl. CPC H04B 1/405; H04L 5/1469

(57) ABSTRACT

In a time division duplex (TDD) communication network, a signal conditioning device includes a first port and a second port for connection on a communications link. A downlink path is adapted for transporting downlink signals from the first port to the second port, and an uplink path is adapted for transporting uplink signals from the second port to the first port. A passive, asymmetric attenuator is adapted for attenuating a signal on the uplink path differently than the signal on the downlink path.

### RELATED APPLICATIONS

This patent application claims the benefit under 35 U.S.C. § 119(e) of U.S. Provisional Patent App. No. 63/454,378, filed Mar. 24, 2023, entitled “PASSIVE RADIO SIGNAL CONDITIONING,” incorporated herein by reference in entirety.

### BACKGROUND

Distributed Antenna Systems (DAS) deployments allow an operator to introduce radio BTS equipment to join a DAS and inject their signal for redistribution within a venue/enterprise for wireless coverage. A Head End (HE) of the DAS employs equipment which converts RF inputs into optical for distribution over fiber, which then gets reconverted back to RF at remote locations for signal re-transmission.

### SUMMARY

A passive approach to condition the transmit portion of the TDD (Time-Division Duplex) signals separately from receive portion without the use of active components and external frame synchronization avoids overdriving a downlink recipient such as a head end. A network supporting a Distributed Antenna System (DAS) employs uplink and downlink signals between a TDD radio and a head end. A signal conditioner attenuates (conditions) the downlink (TX) and uplink (RX) signals independently, generally in circumstances where the downlink signal incurs greater attenuation than the uplink signal to avoid overdriving the head end receiving the downlink signal. Attenuation is performed by connecting/arranging a respective communication path for each of the uplink and downlink signals using passive components. The communication path typically includes circulators and attenuators connected via ports in a passive arrangement that mitigates power requirements.

Configurations herein are based, in part, on the observation that DAS approaches suffer from the shortcoming that power variations between the HE and the DAS radio require attenuation on the transmitted signals, particularly on downlink signals from the DAS radio (radio) which may be operating at a higher power than the HE. Unfortunately, conventional approaches to signal attenuation affect downlink (radio to HE) and uplink (HE to radio) equally, causing excessive attenuation on the uplink signals. It would be beneficial to attenuate, or “condition,” the uplink and downlink signals separately to avoid excessive and/or unnecessary signal attenuation, particularly for the uplink signals.

Some conventional approaches employ digital switching and control circuits, however these require external power and add digital components, increasing cost and reliability concerns. Accordingly, configurations herein substantially overcome the shortcomings of conventional approaches by providing a passive, asymmetric signal conditioning (attenuation) device for conditioning the uplink and downlink signals separately, meaning applying different attenuation values to the uplink and downlink signals. Particularly in a TDD transmission medium, where uplink and downlink signals are separated by alternating timing (time slices) instead of different frequencies, digital switching the attenuation values between uplink and downlink signals requires precise timing control by the digital switching circuits.

In further detail, in a time division duplex (TDD) communication network, a signal conditioning device includes a first port and a second port for connection on a communications link. A downlink path is adapted for transporting downlink signals from the first port to the second port, and an uplink path is adapted for transporting uplink signals from the second port to the first port. A passive, asymmetric attenuator is adapted for attenuating a signal on the uplink path differently than the signal on the downlink path.

The signal conditioning device may take the form of a variable attenuation coaxial adaptor including a downlink path from a first port to a second port such that the downlink path includes a serial connection of attenuation elements for defining an aggregate attenuation for downlink signals. An uplink path from the second port to the first port includes a serial connection of attenuation elements for defining an aggregate attenuation for uplink signals, and a pair of circulators connected between the first port and the second forms a parallel connection between the uplink path and the downlink path between the pair of circulators. The downlink path has attenuation elements including at least a fixed attenuator in series between the pair of circulators, and the uplink path has attenuation elements including at least a fixed attenuator and an isolator in series between the pair of circulators, such that the uplink path experiences different attenuation than the downlink path.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context view of the disclosed passive, signal conditioning device in a DAS network;

FIG. 2 is a schematic diagram of the asymmetric attenuator as in FIG. 1; and

FIG. 3 is a circuit diagram of a particular configuration of the asymmetric attenuator of FIGS. 1 and 2.

### DETAILED DESCRIPTION

Distributed Antenna Systems provide beneficial network infrastructure for providing network services (cellular, Internet and the like) over a predetermined area, such as a building, campus, or enterprise site, when a single antenna is not feasible to support user need. The disclosed approach is particularly beneficial in a communications link between a distributed antenna system (DAS) head end and a TDD radio. The signal conditioning device provides different attenuation values to respective uplink and downlink signals. The asymmetric treatment of the opposed signals is beneficial when the DAS radio operates at a higher power than the head end it connects with. The result is a purely passive scheme to condition at least the transmit portion of the TDD signals without the use of active components and external frame synchronization.

In Distributed Antenna Systems (DAS) deployments, typically an operator provides radio BTS (Base Transceiver Station) equipment to join a DAS and inject their signal for redistribution within a venue/enterprise for wireless coverage. The head end (HE) of the DAS employs equipment which converts RF inputs into optical for distribution over fiber, which then gets reconverted back to RF at Remote locations for signal re-transmission.

The HE of the DAS typically has RF input power limitations. When an operator's radio equipment is capable of transmitting beyond the maximum input rating of the DAS HE equipment, the power must be reduced. This is typically implemented using an external fixed/variable RF attenuator. The main drawback with this approach is that it attenuates both the transmit and receive portions of the radio signal. Due to inherent DAS noise rise and distribution losses, this can limit the performance of the uplink signal and affect capacity and throughput. It is desirable instead to independently attenuate (condition) the transmit and receive portions of the TDD signal separately in order to optimize the uplink (RX) while ensuring the downlink (TX) does not overdrive the DAS HE equipment.

One conventional approach utilizes active RF switches and frame synchronization to separate and condition the paths separately. This approach adds cost and complexity along with reduced reliability due to the nature of active elements and the need for AC/DC power. In contrast, the disclosed approach presents a method to address this without the use of AC/DC power, without switches, and without external frame synchronization by utilizing a passive RF approach with passive components to help isolate the TX and RX signals, condition them, and combine them.

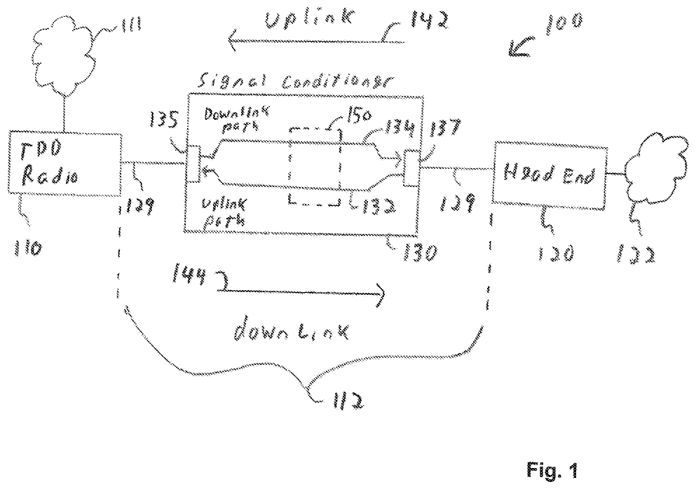

FIG. 1 is a context view of the disclosed passive, signal conditioner device with an asymmetric attenuator in a DAS network. Referring to FIG. 1, in a DAS environment 100, a radio 110 and a HE 120 connect via a communications link 112. The radio 110 connects to a core network 111 of a service provider, typically a cellular, Internet, and/or streaming service provider for a geographic region. The HE 120, in turn, connects to a service network 122, which may be an optical network or other suitable network for providing telecommunications services to a particular venue of users, such as a building, enterprise or campus.

The communications link 112 typically includes coaxial connections via suitable cables having conductors adapted for the expected transmission frequency, typically a 2.5, 3.4 or 3.7 GHZ. As is known in the art, a coaxial cable is simply a central conductor (signal) having an outer ground sheath of a braid or foil, separated by a concentric dielectric for maintaining a constant radius around the conductor. The coaxial nature is particularly amenable for transport of high frequency signals.

Benefits provided by the signal conditioner include an ability to optimize the uplink/downlink signal levels to maximize performance. The passive unit also requires no power, synchronization or battery back-up, and thus promotes higher reliability by avoiding active digital circuits for attenuation switching.

The signal conditional device connects 130 to a coaxial cable 129 defining the communications link 112 for providing asymmetric and independent attenuation based on the type of signal direction, uplink or downlink. Downlink signals 144 are transmit (TX) signals (from the radio 110 perspective) to the HE 120, and travel through the signal conditioning device 130 (signal conditioner) on a downlink path 134. Uplink signals 142 travel from the HE 120 to the radio 110 on an uplink path 132, also called receive (RX) signals from the radio perspective. The passive, asymmetric attenuator 150 is adapted for attenuating signals on the uplink path 132 differently than the signals on the downlink path 134.

The attenuation elements may be connected in a suitable manner for defining the downlink path 132 and the uplink path 134 for independent and different attenuation being imposed on the respective uplink signal 142 and downlink signal 144. Generally this is implemented by two conductive signal pathways and respective arrangement of attenuation elements on each pathway. The attenuation elements may include static or fixed attenuators having a constant attenuation value for signals in both direction, a variable attenuator for selectable bidirectional attenuation, a circulator, which provides a bifurcation of signals at differing attenuations, and an isolator, which has a different attenuation value depending on signal direction.

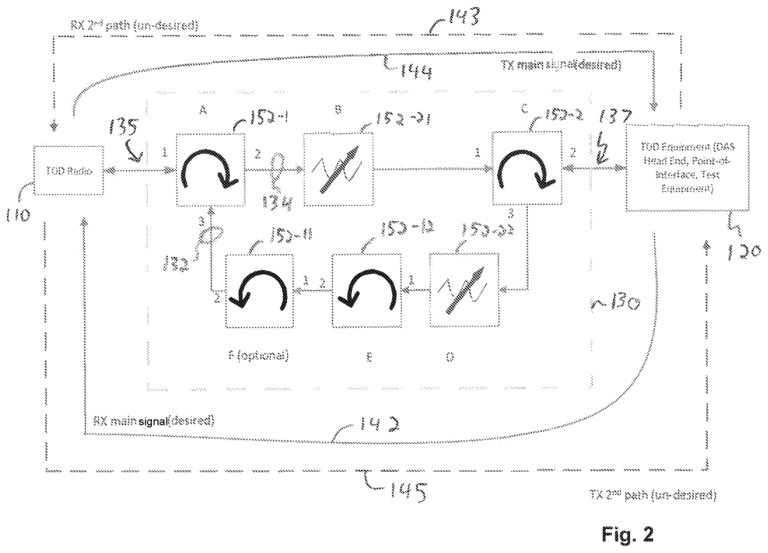

FIG. 2 is a schematic diagram of the asymmetric attenuator as in FIG. 1. Referring to FIGS. 1 and 2, the asymmetric attenuator 150 forms an interconnection of attenuation elements between a first port 135 and a second port 137 where the signal conditioning device 130 connects to the communications link 112. In the example of FIG. 2, the asymmetric attenuator 150 includes a plurality of attenuation elements 152-1 . . . 152-32 (152 generally) connected between the first port 132 and the second port 137. In the asymmetric attenuator 150, the attenuation elements 152 form a plurality of parallel connections defining the uplink path 132 and the downlink path, respectively, between the first port 135 and the second port 137.

In the example of FIG. 2, attenuation elements 152-1 and 152-2 are circulators (A, C in FIG. 2); attenuation elements 152-11 and 152-12 are isolators (E, F in FIG. 2), and attenuation elements 152-21 and 152-22 are attenuators B, D in FIG. 2). Each of the uplink 132 and downlink 134 paths include at least one attenuator, which may be either fixed or variable. The interconnection of attenuation elements forms a parallel circuit arrangement for the uplink path 132 and the downlink path 134.

The isolator 152-11 is optional, as the fixed attenuator D and isolator E provide sufficient attenuation. In the asymmetric attenuator 150, the uplink path 132 running between the circulators 152-1, 152-2 includes a serial connection of uplink attenuation elements 152, where the uplink attenuation elements including at least fixed attenuator D and an isolator E. The downlink path 134 running between the circulators 152-1, 152-2 includes a serial connection of downlink attenuation elements 152, including at least a fixed attenuator B.

Since the attenuation elements 152 are passive, and do not rely on digital logic or switching, the signal response follows a continuous curve and the connected attenuation elements 152 typically result in an undesired signal substantially smaller than the intended uplink 142 and downlink 144 signals. The interconnection between the attenuation elements 152 accommodates and attenuates the undesired signal on a 2^{nd} uplink (RX) path 143 and a 2^{nd} downlink (TX) path 145. The overall result is an interconnection of attenuation elements for providing different uplink 132 and downlink 134 attenuation using passive components without digital switching or circuitry based on a predetermined target signal-to-interference (or signal-to-noise SNR) ratio yet attenuating the undesired signal through the analog components to a substantially negligible or acceptable level. In general, the asymmetric attenuator 150 is configured to provide greater attenuation on the downlink path 134 than the uplink path 132, where the difference between the attenuation on the uplink path and the attenuation on the downlink path is selected based on a signal-to-interference ratio.

Referring more specifically to the example of FIG. 2, the downlink path 134 is adapted for transporting downlink signals from the first port 135 to the second port 137. The downlink path 134 defines a TX main signal (desired downlink signal 144) that passes through circulator (A) (via ports 1-2), is attenuated by attenuator (B) and then passes through circulator (C) (via ports 1-2) to the HE 120. In this downlink direction the circulators present minimal insertion losses to the desired signal.

A TX 2nd path 145 (undesired) passes through circulator (A) (via ports 1-3) and suffers attenuation. It again passes through isolators/circulators (F & E) (via ports 2-1) and suffers additional attenuation. attenuator (D) provides attenuation, finally circulator (C) (via port 3-2) provides more attenuation. Through the combination of attenuation in this secondary path, we can manage the level of the unwanted TX signal such that the combination of the unwanted and desired TX signals does not impact the system performance of the intended downlink transmission.

The uplink path 132 is adapted for transporting uplink signals from the second port 137 to the first port 135. The uplink path 132 carries uplink signals as the RX main signal (desired uplink signal 142) enters circulator (C) (via port 2-3), passes through attenuator (D) and is attenuated generally less than level of attenuator (B), passes through isolators/circulators (E&F) (via ports 1-2 respectively) then through circulator (A) (via ports 3-1). In this uplink direction, circulators present minimal insertion losses to the desired signal.

An RX 2nd path 143 (undesired) enters Circular (C) (via ports 2-1) and is attenuated, goes through attenuator (B) for additional attenuation, and finally circulator (A) (via ports 2-1) with additional attenuation. Through the combination of attenuation in this secondary path, we can manage the level of the unwanted RX signal such that the combination of the unwanted and desired RX signals does not impact the system performance of the intended uplink transmission.

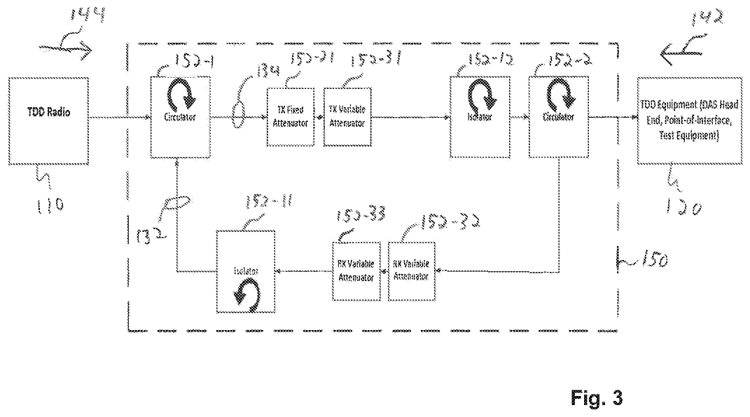

FIG. 3 is a circuit diagram of a particular configuration asymmetric attenuator of FIGS. 1 and 2. FIG. 3 depicts a particular configuration of the signal conditioner device to connect TDD signals from a BTS to a DAS system. The TDD TX (uplink 142) and RX (downlink 144) signals are separated, independently conditioned, and combined using passive techniques. The analog technique provides minimal group delay impact and does not modify the TDD frame structure.

The configuration of FIG. 3 is capable of 30 dB variable attenuation on the downlink path 134 and 60 dB variable attenuation on the uplink path 132. The TDD Channel downlink output nominal range of the unit is −6 dBm to +24 dBm at 20 watts input power. Being suited for TDD signals, the signals on the downlink path 134 are at the same frequency and in a different time slot than the signals on the uplink path 132.

In FIG. 3, an alternate interconnection of attenuation elements can be observed. As above, the asymmetric attenuator 150 is collectively a passive component devoid of external power connections due to the individual, passive attenuation elements 152. As in FIG. 2, the attenuation elements 152 include a pair of circulators 152-1, 152-2 defining the uplink path 132 and the downlink path 134 in parallel, and directing the uplink signal 142 and downlink signal 144 through the respective parallel paths for effecting the attenuation differential. Attenuation may be modified by providing various combinations of variable attenuators and isolators. In FIGS. 2 and 3, the uplink path 132 includes at least a fixed or variable attenuator and an isolator, and the downlink path 134 includes at least a fixed or variable attenuator.

The uplink path 132 therefore includes one or more attenuation elements 152 in series aggregating to an uplink attenuation value, and the downlink path has one or more attenuation elements 152 in series aggregating to a downlink attenuation value, connected in parallel by the circulators 152-1,152-2.

The asymmetrical attenuator 150 of FIG. 3 builds on this by including a fixed attenuator 152-21, variable attenuator 152-31, and an isolator 152-12 on the down link path 134 in series between the circulators 152-1, 152-2. On the uplink path 132, a serial connection of two variable attenuators 152-32, 152-33 and an isolator 152-11 aggregate to an uplink attenuation value, including of course the attenuation imposed from the circulators 152-1 . . . 152-2.

The disclosed approach therefore provides a passive component solution to downlink attenuation for avoiding overdriving the HE from the radio 110, while not unnecessarily attenuating the uplink signal, in a TDD communication link 112. Unlike an FDD (Frequency Division) transmission, in a TDD network, bidirectional communication occurs at the same frequency and needs to be switched or otherwise coordinated. The disclosed device has an RF input and an RF output, and handles downlink and uplink from the TDD radio to the TDD equipment (i.e. head end). The disclosed device includes variable attenuators and circulators such that attenuation on the intended transmit path is less than the attenuation on the intended uplink path. An example configuration might have 40 dB attenuation downlink and 30 dB attenuation for uplink, but the actual attenuation will be tuned based on desired signal strength and response. A small undesired leakage signal will emerge from the circulators due to the nature of the device, which will also be optimized by tuning.

The attenuators will typically be step attenuators, for simplicity and cost, and may have a fixed and variable component, i.e. 15-30 dB, however any suitable variable attenuator will suffice. In a typical 5G communications network, operation may be in a 2.5, 3.4 or 3.7 GHz band, and the device may expect a 200 MHz range within the band, however other suitable ranges may be employed.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a time division duplex (TDD) communication network, a signal conditioning device, comprising:
a first port and a second port;
a downlink path adapted for transporting downlink signals from the first port to the second port;
an uplink path adapted for transporting uplink signals from the second port to the first port; and
a passive, asymmetric attenuator adapted for attenuating a signal on the uplink path differently than the signal on the downlink path.

2. The device of claim 1 wherein the asymmetric attenuator is configured to provide greater attenuation on the downlink path than the uplink path.

3. The device of claim 1 wherein a difference between the attenuation on the uplink path and the attenuation on the downlink path is selected based on a signal-to-interference ratio.

4. The device of claim 1 wherein the signals on the downlink path are at the same frequency and in a different time slot than the signals on the uplink path.

5. The device of claim 1 wherein the asymmetric attenuator is a passive component devoid of external power connections.

6. The device of claim 1 wherein the asymmetric attenuator further comprises:
a plurality of attenuation elements connected between the first port and the second port,
the attenuation elements forming a plurality of parallel connections defining the uplink path and the downlink path, respectively, between the first port and the second port.

7. The device of claim 6 wherein the uplink path includes a serial connection of uplink attenuation elements, the uplink attenuation elements including a fixed attenuator and an isolator.

8. The device of claim 6 wherein the downlink path includes a serial connection of downlink attenuation elements, the downlink attenuation elements including a fixed attenuator.

9. The device of claim 6 wherein the attenuation elements further comprise:
a pair of circulators, the pair of circulators defining the uplink path and the downlink path in parallel;
the uplink path having one or more attenuation elements aggregating to an uplink attenuation;
the downlink path having one or more attenuation elements aggregating to a downlink attenuation.

10. The device of claim 9 wherein the uplink path includes at least one of a fixed or variable attenuator and an isolator; and
the downlink path includes a fixed or variable attenuator.

11. A variable attenuation coaxial adaptor, comprising:
a downlink path from a first port to a second port, the downlink path including a serial connection of attenuation elements for defining an aggregate attenuation for downlink signals;
an uplink path from the second port to the first port, the uplink path including a serial connection of attenuation elements for defining an aggregate attenuation for uplink signals;
a pair of circulators connected between the first port and the second port, the uplink path and the downlink path forming a parallel connection between the pair of circulators;
the downlink path having attenuation elements including at least a fixed attenuator in series between the pair of circulators;
the uplink path having attenuation elements including at least an attenuator and an isolator in series between the pair of circulators,
the uplink path experiencing different attenuation than the downlink path.

12. The device of claim 11 wherein the downlink path undergoes greater attenuation than the uplink path.

13. In a TDD (Time-Division Duplexing) network supporting a distributed antenna system having uplink and downlink signals between a TDD radio and a head end, a method of conditioning a transmit signal, comprising:
attenuating the downlink (TX) and uplink (RX) signals independently, wherein the downlink signal incurs greater attenuation than the uplink signal to avoid overdriving the head end receiving the downlink signal.

14. The method of claim 13, further comprising connecting a respective communication path for each of the uplink and downlink signals using passive components, the uplink and downlink signals traversing the paths.

15. The method of claim 14 wherein the communication path includes circulators and attenuators connected via ports.
